(19) United States
(12) Patent Application Publication
(10) Pub. No.: US 2005/0278263 A1
(43) Pub. Date: Dec. 15, 2005

(54) System and method for variable price postage stamp and billing

(76) Inventors: Alan Roy Hollander, Needham, MA (US); Kale Sanjeev, Cambridge, MA (US)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 11/143,264

(22) Filed: Jun. 2, 2005

Related U.S. Application Data
(60) Provisional application No. 60/578,923, filed on Jun. 11, 2004.

(51) Int. Cl. G06F 17/00

(52) U.S. Cl. 705/402

(57) ABSTRACT

A postal customer obtains (directly or indirectly) from a post office one or more labels, each having a unique identifier. At the time of obtaining the labels or later, the customer associates a payment account such as a credit card account or bank account with the label identifier in a database and authorizes postage charges to the payment account. At a later time, a label is addressed and other delivery information is supplied, and then affixed to a package for delivery. The package is delivered to and processed at a post office, where the label is read and the appropriate postage is determined by the post office without interaction with the customer. By accessing the database, the payment account associated with the unique identifier is determined and billed for such postage by the post office.

### CROSS-REFERENCE TO RELATED APPLICATION

This application claims priority under 35 USC 119(e) to provisional application Ser. No. 60/578,923, filed Jun. 11, 2004 (attorney docket H0686.70000 US00).

### BACKGROUND OF THE INVENTION

1. Field of the Invention

The present invention relates to a postage system and method which permits variable cost postage to be charged to a credit card or other account, and which frees the customer from any requirement to use fixed-price stamps or any mechanical or electronic device such as a postage meter, computer, or printer, or to maintain any special supplies.

2. Brief Description of Related Developments

Postage stamps have been utilized over a long period as a means for a customer to pay a postal service (typically governmental or quasi-governmental) for its fees for delivering letters and packages. Postage stamps typically have a preset value shown on the stamp. Sometimes, however, they instead are printed with a reference mark, such as a letter of the alphabet, that can then be associated with a preset value (such as when postal rates are to be changed but the new rate is not determined at the time the stamps are printed). The cost of postage for a postal (mail) item (e.g., letter or package) may be determined by such factors as the package weight, size, contents, destination, type of delivery (e.g., ground or air), promised speed of delivery, and any services, e.g., tracking (“Delivery Factors”).

Postage meters have been utilized over a long period, as an alternative to stamps, to print postage indicia on mail items or on labels to be affixed to mail items. The postal meter can be leased or rented from commercial enterprises authorized by a postal authority. The use of a postage meter relieves the user from having to keep a large quantity of stamps and is also intended to reduce the pilferage that often occurs when a supply of stamps is available in a company mail room. Generally, the indicia printed on a metered postage label or item includes at least the postage charge, the date on which the indicium is printed, identification of the postage meter, and an identification of the postal authority.

As the need and desire to include more information on a mail item has developed, the United States Postal Service (USPS) has proposed the Information-Based Indicia Program (the “IBIP”). IBIP is a distributed trusted system which is expected to support new methods of applying postage using postal security devices (a “PSD”), such as PC-based methods, in addition to, and eventually in lieu of, the current approach, which typically relies on a postage meter to mechanically print indicia on mail pieces. The IBIP requires printing large, high density, two dimensional bar codes on mail pieces.

A postage meter or PSD must affix to each mail piece postage indicia, the value of which must equal or exceed the exact amount of postage due for the mail piece when mailed.

For a postal customer, there is complexity in determining the appropriate postage cost for the mailing of a package, including the weighing of a package and determination of the appropriate rate based on a variety of Delivery Factors. Also, the use of traditional stamps requires the retention of a variety of denominations of stamps to accommodate the variety of rates. The alternative of bringing the package to a customer service counter at a post office requires significant time and effort for the customer to wait in line to be served, to wait for the appropriate postage to be determined, and to wait while payment is processed. For a post office, the cost of staffing a customer service counter to complete the transaction is significantly more than it would be if the transaction were completed as a back office function, especially if it were partially or fully automated. A convenient alternative is, therefore, desirable.

There is a significant cost and complexity in acquiring the use of and using a postage meter or PSD to print postage, especially given the reoccurring changes in postal processes and rates. Published U.S. patent application 2003/0225711 (published Dec. 4, 2003) proposes the use of a franking module which would allow a postal customer to apply a unique indicia to an item of mail for authorizing postal transactions. The indicia would not include postage and the franking module would have no capability to store and account for postage. The identification data represented by said indicia would include a customer account number registered at the post office for authorization and billing. The indicia would be read and the postage value would be calculated by a post office processor remote from the franking module and the amount of postage would be debited to the customer's account as the postal item clears the initial processing. While this system provides a possible solution to enable a postal customer to avoid having to calculate the necessary postage for a package, it still requires the postal customer to purchase or rent a franking module and to establish and maintain an account with the post office. For those postal customers who do not want to incur the cost of acquiring a franking module or the effort to use one and for those postal customers who do not want to incur the cost or effort to establish an account with the post office, an alternative is, therefore, desirable.

Another alternative has been provided in recent years via the Internet. A user can establish an account with a company authorized by the United States Postal Service such as stamps.com (www.stamps.com), Endicia by Dazzle (www.endicia.com), or eBay (www.ebay.com), and can print postage labels on the user's personal computer. The user pays the company and the company, in turn, pays the post office. While perhaps less costly than the use of a postage meter, the user needs to establish an account with the company and an Internet Service Provider, the user requires a personal computer, and needs to determine and then print the correct postage on a printer connected to the computer. And in the event of a printer jam, the printing of incorrect postage, or a decision later not to use the label or ship the package, the customer needs to apply for a refund usually within a specified period of time. The USPS also offers a limited option to print postage online for certain classes of mail such as Express Mail and Priority Mail and allows customers to hand the packages to their letter carrier. Similarly as in the case of private companies, the user needs to use a personal computer, printer, and have a connection to the Internet, and still needs to apply for a refund in the event of a printer jam, the printing of incorrect postage, or a decision later not the use the label or ship the package.

Published U.S. patent application 2004/0083189 (published Apr. 29, 2004) describes a method of creating unique identifiers by postage vendors such as Pitney Bowes or Neopost and through a computer network, these unique identifiers would be made available to mailers or companies processing mail on behalf of mailers (such as companies which prepare bills and mail them on behalf of mailers) who would, through the use of a computer of other electronic devices, print the unique identifiers onto the mailpieces or onto labels to be applied to the mailpieces, and then as the post office processes the mail, the postage vendor would be notified of the use of the unique identifiers and would charge the mailers for the postage used. This method is intended to substitute for the use of current postage meters which enable fraudulent use of postage by either manipulating the meters to print indicia that are not accounted for or by forging postage meter indicia, and is also intended to substitute for bulk mail pre-printed indicium which enables fraudulent under-reporting. This method assumes that the mailer has established an account with the postage vendor or with a company which processes mail on behalf of the mailer and does not describe any method by which that account would be established. In addition, the methods described are not intended to enable a postal customer to obtain the unique identifier without it being part of the process of preparing a particular mailpiece. In fact, the method described assumes that the mailer is at the time of preparing the mailpiece for mailing connected to a data network or is at a kiosk which is connected to a data network. The method of preparing a mailpiece, as exemplified in the claims, is based upon the unique identifier containing the appropriate rated postage for that particular mailpiece.

Private shippers, such as UPS, enable their customers who establish an account to ship a package without having to wait on a line at a customer service counter, without having to pay for the shipment at the time of shipment, and without knowing the cost for shipping an item. The customer uses a pre-assigned account number on a shipping label and the shipping company determines the appropriate charge and bills the customer. As an alternative, the customer without an account at a private shipper may also avoid having to wait on a line at a customer service counter if the private shipper allows the customer to write their credit card number on the shipping label, but most customers would not want to disclose their credit card number alongside their name and address and signature in this manner due to security concerns.

A need thus exists for a system that will bring to postal customers the convenience of fewer visits to the post office, less waiting in lines at a post office especially during holiday periods, and flexible postage, without an investment in postage meters, computers or other specialized hardware, and without having to establish an account with the post office or private shipper.

### SUMMARY OF THE INVENTION

In accordance with the foregoing needs, there is disclosed a method and system which (a) does not require a customer to establish an account with a post office (but allows for one) or with a private shipping company, (b) eliminates the need for a customer to purchase a scale to weigh packages, (c) eliminates the need to purchase and maintain a sufficient quantity of stamps in a variety of denominations, (d) eliminates the need to use a postage meter or other franking module, personal computer and printer, or other PSD, (e) avoids the need for the customer to disclose credit card or other account information when the package is mailed, (f) eliminates the need for the customer to determine or print the correct postage (and possibly make a mistake in doing so) and (g) eliminates the need for the customer to engage in any personal interaction with a post office or private shipping company in order to ship a package. (As used herein, the term “package” is employed to mean any item to be shipped from a sender to an intended receiver, and includes a letter.) On the side of the post office, there is a concomitant reduction in customer service personnel required.

Instead of stamps, the method and system instead uses labels to connote the payment of postage. Labels are obtained in various ways, including but not limited to purchase (from the post office or authorized agent, by mail or from a vending machine) with a credit card, debit card or other payment account. Labels may be obtained for free and subsequently activated by associating them with a payment account. The labels are associated with the payment account, in a computer data structure under the control of the post office or a contracted third-party. Each label has a unique identifier that is associated with the payment account at the time of purchase or activation. At the time of shipment, the postal customer completes the label by hand, affixes the label to the item to be shipped and then drops off the item at a post office (or hands the item to a postal carrier who delivers the item to a post office) where it processed, the label is read (e.g., scanned by a laser or other scanning device under control of a computer that interacts with label and postage databases), the postage is determined, and the associated payment account is billed electronically. The scanning may be performed with, for example, a laser scanner that scans bar codes and/or with one or more other scanners capable of scanning and reading other forms of printed or other indicia (e.g., magnetic coding, handwriting, etc.). The nature of the scanner does not form part of, or limit, the invention.

The need is thus avoided for personal customer interaction at the post office each time the customer ships a package.

Additionally, a postal customer may provide the shipping labels (with or without the address section completed) to another person to enable the other person to ship a package to the sender or another recipient without cost to the other person.

In the system, a postal customer who posts a mail package uses a label containing a unique identifier that is associated in a centralized (or distributed and synchronized) database or other data structure to the postal customer's payment account which is used at the time of the purchase or activation of the label. Such label preferably also contains return and recipient address information and such other information completed by the postal customer to enable the post office, after applying its postal processes to determine the appropriate postage, to charge such postage to the postal customer's payment account, all without any further interaction with the postal customer after the purchase or activation of the label or package of labels and without the postal customer having to establish an account with the post office. (However the payment account may, if desired, be maintained with the post office.) To simplify the contents of the label which needs to be completed by the customer, or to avoid excessive postage charges, the post office may limit the use of the labels for packages which do not contain a restricted list of items (e.g., liquids or plants), and could restrict the type of services provided (e.g., Cash on Delivery or Return Receipt).

For all purposes herein, a reference to a payment account or credit card or credit card account includes a credit card, a debit card, whether issued by a third party issuer, or by the post office itself in a manner similar to those issued by retailers in the form of a “gift card” which is established for a fixed amount paid in advance and then debited for subsequent purchase transactions. In addition, for all purposes herein, a reference to a credit card includes a bank account or third-party financial intermediary account such as a PayPal account (see www.paypal.com) which may be used to purchase labels and to which the post office may then later process charges for postage.

The unique identifier may be a number, alphanumeric code, a one- or two-dimensional bar code, or other representation that is machine readable, or may be stored as data in a RFID device (integral with the label) and the other information may be coded to be machine readable. The terms “read” and “scan” as used herein are intended to encompass any means appropriate to extract automatically from the label the unique identifier, with or without other data. Such other information may include information about the contents of the package and the type of delivery desired by the postal customer, such as fastest delivery or lowest cost and such information may be coded on the label in a manner to make such information machine readable.

Other advantages, novel features, and objects of the invention, and aspects and embodiments thereof, will become apparent from the following detailed description of the invention, including aspects and embodiments thereof, when considered in conjunction with the accompanying drawings, one or more of which may be schematic and which are not intended to be drawn to scale. In the figures, each identical or nearly identical component, step or act that is illustrated in various figures is represented by a single numeral. For purposes of clarity, not every component, step or act is labeled in every figure, nor is every component, step or act of each embodiment or aspect of the invention shown where illustration is not necessary to allow those of ordinary skill in the art to understand the invention.

### BRIEF DESCRIPTION OF THE DRAWINGS

The invention will be more fully appreciated from the detailed description which follows, which should be read in conjunction with the accompanying drawings, wherein:

FIG. 1 is a flow chart of an overall process for vending and using postage labels as taught herein;

FIG. 2 is a diagrammatic illustration of an illustrative data structure that might be maintained by the post office to practice the methods, or as part of the system, discussed herein;

FIG. 3 is a flow chart of an illustrative process implemented by a post office for practicing the methods taught herein;

FIG. 4 is an illustration of a typical postal label for use with the methods and systems taught herein; and

FIG. 5 is an illustration of typical labeling that might be used on a book of labels for use with the methods and systems taught herein.

### DETAILED DESCRIPTION

The function and advantage of the above-summarized and other embodiments of the present invention will be more fully understood from the examples described below. The following examples are intended to illustrate the benefits of the present invention, not to exemplify the full scope of the invention.

As an aid to comprehension of the written description and the claims, we note that certain terms are intended to have defined meanings, as follows:

“Computer” includes any manner of information processor, be it analog or digital, special purpose or general purpose, localized or distributed, programmable or pre-programmed by design;

“Delivering” includes causing another to make a delivery in addition to personally effecting a delivery;

“Comprising”, “including”, “carrying”, “having”, “containing”, “involving”, and the like are to be understood to be open-ended, i.e., to mean including but not limited to; only the transitional phrases “consisting of” and “consisting essentially of”, respectively, shall be closed or semi-closed transitional phrases, as set forth, with respect to claims, in the United States Patent Office Manual of Patent Examining Procedures (Original Eighth Edition, August 2001), Section 2111.03;

“Data structure” means an arrangement of data defined by computer-readable signals, which signals may be read by a computer system, stored on a medium associated with a computer system (e.g., in a memory, on a disk, etc.) and may be transmitted to one or more other computer systems over a communications medium such as, for example, a network; and

“Network” or a “communications network” is group of two or more devices interconnected by one or more segments of transmission media on which communications may be exchanged between the devices. Each segment may be any of a plurality of types of transmission media, including one or more electrical or optical wires or cables made of metal and/or optical fiber, air (e.g., using wireless transmission over carrier waves) or any combination of these transmission media.

According to a first aspect, further discussed below, there was provided a method for posting mail packages by a postal customer. The customer purchases, with a credit card coupled to a credit card account, a label having a unique identifier, and the purchase includes authorizing subsequent postage charges to the credit card account. In a computer data structure, the label identifier is then associated with the credit card. A computer reads information from the data structure, determines whether the label identifier is valid, and correspondingly updates the data structure with the label identifier status as valid or invalid. At or subsequent to the purchase, the postal customer affixes the label to a package and delivers or arranges for the delivery of the package to a post office. At a postal facility, the label is scanned and information is obtained from the package, such as the destination address or postal code, to enable determination of the appropriate postage. The data structure is then accessed to determine whether the label identifier is valid and, if so, the determined postage is charged to the customer's credit card without the necessity of further interaction with the customer beyond the original purchase of the package of labels.

The credit card may be issued by the post office or it may not be issued by the post office but by another entity, in which case the customer need not establish an account with the post office.

According to another aspect of the invention, a method is shown for posting mail packages in a similar, but slightly different way. The customer purchases a label having a unique identifier and authorizes subsequent postage charges to be debited from a third-party account of the customer. The label identifier is associated with the third party account in a computer data structure. A computer is operated to determine whether the label identifier is valid. At or subsequent to the purchase, the customer affixes the label to a package and delivers or causes to be delivered to a post office, the package. At a postal facility, the label is scanned and information is obtained from the package to enable determination of the appropriate postage. The data structure has been accessed to determine whether the label identifier is valid and, if so, the determined postage is debited from the third-party account. Again, the customer need have no further interaction with any postal personnel after the purchase of the package of labels.

The third-party account may, for example, be a bank account of the customer. It also may be an account maintained by the customer with a third party and the third party may charge a fourth-party credit account of the customer and pay the post office.

The term “post office” is not intended to be limited to government-operated postal services, but also encompasses quasi-governmental organizations and private shippers.

In either of the above aspects, the unique identifier on the label preferably is machine readable. It may, for example, be a printed bar code or an RFID tag.

Another aspect of the invention is a postal system which comprises means for reading from a label a unique identifier associated with the label; means responsive to the read unique identifier for identifying the payment account with which the label has been previously associated; means for verifying the unique identifier as valid; means for determining the postage required to deliver the item on which the label is placed; means responsive to the means for verifying, for, after verifying the validity of a unique identifier, charging the postage to the payment account. As above, the payment account may be a credit card account, a bank account, or other account.

A still further aspect of the invention is a postage label vending system which comprises means for reading a credit card, means for associating a unique identifier from a postage label with a credit card account number read by the means for reading, and means for storing the unique identifier in association with the credit card account number.

Yet another aspect of the invention is a method for posting mail packages by a postal customer as follows: The postal customer obtains a label having a unique identifier. The customer activates the label by associating the label in a postal data structure (i.e., in a computer memory maintained for the post office or postal system) with a payment account of the customer, and authorizing current or subsequent postage charges to said account. At or subsequent to the activation, the customer affixes the label to a package and delivers the package or causes the package to be delivered to a post office. At a postal facility, the label is scanned and information provided by the customer is obtained from the package to enable determination of the appropriate postage. The post office accesses a data structure to determine whether the label identifier is valid and, if so, charges the determined postage to the associated account, no further interaction with the customer being required.

According to yet another aspect of the invention, a method is shown for posting mail packages by a customer of a package processor. The customer purchases, by authorizing charge or debiting to a payment account, a label having a unique identifier, and authorizes obtaining payment for subsequent shipping charges from said account. In a data structure, the label identifier is associated with said account. A computer is operated to access the data structure and determine if the label identifier is valid, then to update the data structure correspondingly. At or subsequent to the purchase, the customer affixes the label to a package and the customer delivers, or arranges for the delivery of, the package to the package processor. The package processor scans the label and obtains from the package other information, completed by the customer, and enabling determination of the appropriate shipping charges. A computer (typically of the package processor) is operated to access the data structure to determine whether the label identifier is valid. If it is, the determined shipping charges are charged to the payment account, without further interaction with the customer being required. If the package processor is a post office, it then places postage on the package. If the package is to be delivered to a post office, the package processor places appropriate postage on the package, or if the package is to be delivered to a private shipper, an account number is placed on the package. The account number may be the customer's account number or an account number of the package processor. The package is delivered to a post office or to the private shipper, as appropriate. If to a private shipper, the private shipper then bills the appropriate shipping charge to the package processor.

Referring now to the accompanying drawing figures, an example system and method suitable for practicing certain aspects of the invention can be described as follows:

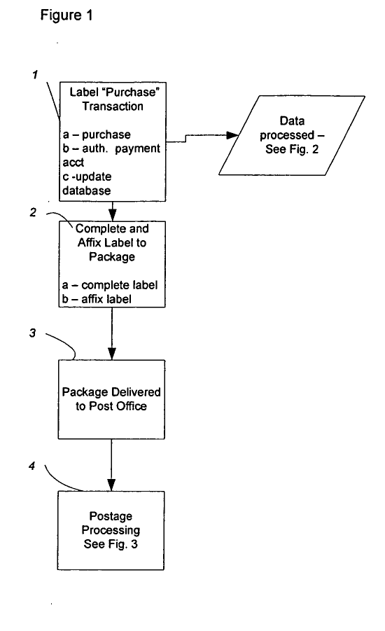

We begin with FIG. 1. Act 1 thereof is referred to as a “Label Purchase Transaction.” It involves at least one sub-act 1a, and may involve two more sub-acts, 1b, 1c.

In sub-act “1a” a customer purchases a label or group of labels, with each label having a unique identifier (the “Label ‘Purchase’ Transaction”). The Label Purchase Transaction can be made (i) at a post office counter, (ii) at a vending machine located at a post office or other location, or (iii) by telephone order or Internet order with the labels then locally printed or delivered to the customer by the post office or delivery service. The term “purchase” is not meant to preclude a zero price, as will become apparent below.

In sub-act “1b,” at the time of the Label Purchase Transaction, the customer may (but need not) authorize the automatic charge to a payment account of the postage which is to be incurred by the customer whenever a package is shipped using one of the labels purchased in the Label Purchase Transaction. The authorization may have a maximum dollar limit imposed by the customer, the post office, or the customer's credit card issuer or bank. If a spending limit is imposed, then preferably a mechanism is provided for obtaining an increase in the limit (e.g., an Internet web site the customer can contact for this purpose). If the customer does not authorize the automatic charge at the time of the Label Purchase Transaction (which might be better termed the Label Delivery Transaction), then at a later time, not shown, the customer activates the label by authorizing the automatic charge.

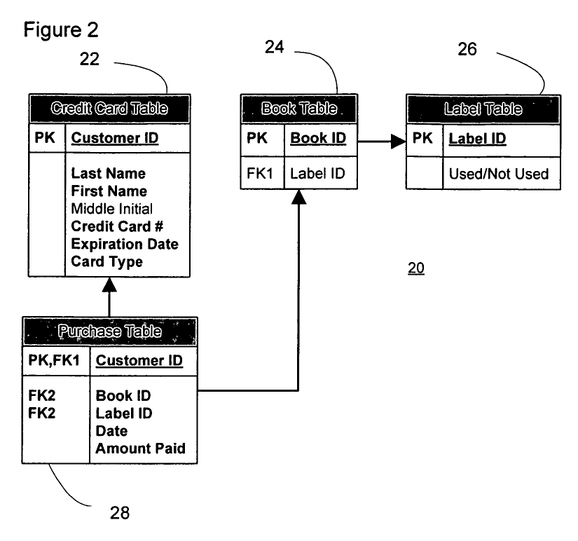

In sub-act “1c,” assuming the authorization was provided in sub-act 1b, the post office creates in a centralized (or distributed and synchronized) database 20 (see FIG. 2) a relationship between the payment account number and each of the unique identifiers on the labels purchased in the Label Purchase Transaction.

Database 20 of FIG. 2 may, for example, be a relational database comprising, for example, four tables, 22-28. Table 22, called the Credit Card Table or Payment Account Table records, indexed by Customer ID (each customer being given a unique identifier), information such as the customer's name and credit card or other payment account identification and related information such as account or card expiration date, name and information for accessing the institution holding the account to facilitate electronic access, etc. Table 24, called the Book Table, identifies under the identifier for a book of labels, each individual label in the book. Table 26, called the Label Table, contains the unique identifiers of validated labels or of all labels along with a flag indicating whether the label has been validated and not previously canceled. Table 28, called the Purchase Table, is indexed by customer ID and contains information about each purchase transaction, including the date of the purchase, the identifier of each book or label purchased, and the amount paid. Naturally, other table arrangements, indexing and contents may be employed, the invention not being limited to the example data structure of FIG. 2.

After the Label Purchase Transaction, Act 2 is executed, an act called “Complete and Affix Label to Package.” It comprises but two sub-acts. In a first sub-act, 2a, when the customer wants to ship a package, the customer completes the required information on one of the labels, including (a) delivery address, (b) return address, (c) type of delivery requested, and (d) if applicable, the package contents. In a second sub-act, 2b, the customer affixes the completed label to the package.

Then, in Act 3, “Package Delivered to Post Office,” the customer (or someone at the customer's behest) delivers the package with the completed label to a post office, hands it to a postal carrier, or arranges for it to be picked up by the post office.

Upon receipt of the package, the post office executes Act 4, “Postage Processing.” The Post Office manually records or automatically scans the unique identifier on the label and validates the label. That is, it queries the database to determine if the unique identifier is (a) contained in the database, (b) has not been previously used and (c) has been associated with a payment account (i.e., it is a “valid identifier”). If the unique identifier is a valid identifier, then the postage for the package is determined, and the payment account related to such unique identifier is processed for payment in the amount of the postage (the “Postage Processing Transaction”). If the unique identifier is not a valid identifier or the payment transaction is not approved for payment as part of the Postage Processing Transaction, the package is not processed for shipment, and the sender (based on the return address) is notified that the package will not be shipped until payment is received (or the package is returned). If an e-mail address was provided at the time the label was purchased, then preferably the notification is sent by e-mail, automatically. If the transaction is approved for payment as part of the Postage Processing Transaction act, (a) the package is processed for shipment and delivered to the recipient and (b) an attribute is changed in the centralized database to indicate that the unique identifier has been used, effectively canceling the label on the package.

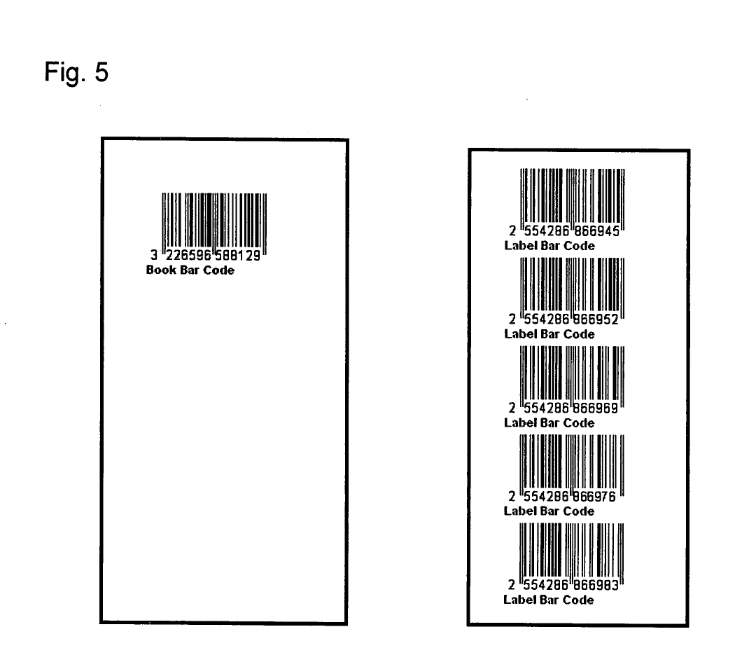

Any labels that are sold as a group of labels may be packaged with a separate unique identifier which identifies all of the labels in the book of labels (the “Book ID”). See FIG. 5. The database may use the Book ID to associate the payment account with the unique identifiers of the individual labels contained in the book. See FIG. 2—Book Table 24 and Label Table 26. This would avoid the necessity of having to scan or type each of the individual label unique identifiers at the time of purchase.

The label and book examples of FIGS. 2 and 5 make use of bar codes to present scanable unique identifiers but other indicia may be employed, instead. Preferably, machine-readable, of course. Additional printing may be provided, such as alpha-numeric renderings of the label or book identifiers, instructions, logos, security markings, and so forth. An alpha-numeric rendering may be used in association with the identifier on the book, but is then not required on the individual labels contained inside the book.

Labels may be pre-printed prior to purchase, or may be printed at the time of purchase. If printed at the time of purchase, the labels may be printed at a customer service counter or at a kiosk. If an RFID tag is used, it may be pre-programmed or programmed at the time of purchase.

The fact that each label must be associated with a payment account in order to be used provides security against the unauthorized use of a label that may be stolen. Stolen labels have no value unless purchased or activated, so in the case of pre-printed labels stolen from a vending machine or from a customer service counter, the labels would not be useable because when checked in the database, there would be no payment account associated with the unique identifier of the label and therefore the package would not be shipped. In the case of a label stolen from a postal customer (or lost by the customer) after purchase or activation, the postal customer would be able to notify the post office that the labels are stolen or lost, in which event the post office can flag the labels in its database by, for example, appropriately changing an attribute of the field containing the unique identifiers in the database, so that the unique identifiers will no longer be valid. Preferably, the labels are purchased for a nominal amount (or for a zero amount) and the cancellation can be effected without having to issue a refund to the customer. Similarly, if a label is damaged or used on a package which the customer decides not to ship, the customer would not have to seek a refund.

If payment was authorized to a credit card account, the credit card may no longer be valid at the time of package processing by the post office. In that event, the post office can return the package to the shipper (but would only do so for cost and security reasons if the shipper's return address which is provided on the label is a local address) or it can deliver a card (or e-mail message if an e-mail address is previously obtained from the shipper) to the shipper stating that the package will not be delivered to the recipient without an alternative payment account. If the package is not returned to the shipper, not picked up by the shipper, and an alternative payment is not made, then the package can be handled by the post office in a manner similar to that used for other undeliverable packages. In the case of the USPS, the Postal Operations Manual contains the USPS policy and procedures for handling and disposing of “dead mail”, i.e., mail that is or becomes undeliverable and cannot be returned to the sender, through sale at auction or by donation to institutions.

As an alternative for a customer who doesn't have a credit or debit card issued by a third party or does not want to use such a credit or debit card, the post office may enable the customer to purchase a debit card for a specific monetary amount for cash and enable such debit card to be used as a payment account in place of a credit card. As a further option, the post office may issue a debit card linked to the customer's bank account. Or the post office can elect to maintain deposit accounts for customers who may from time to time deposit funds to cover the cost of future postage.

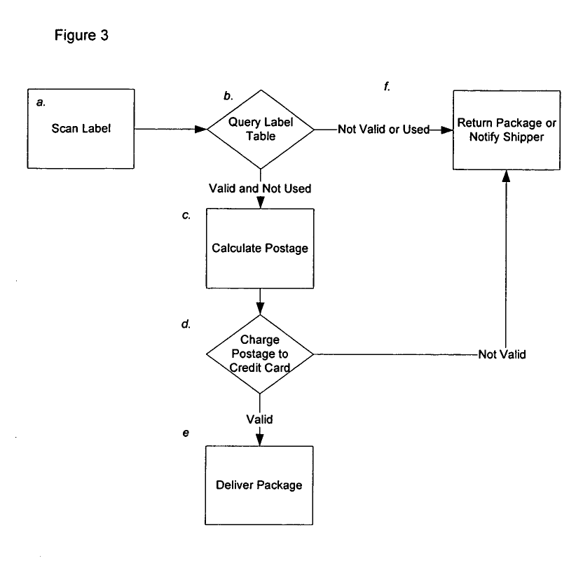

FIG. 3 illustrates a typical process implemented at a post office package intake facility. Note that not every post office need be considered an intake facility. Local post offices can feed regional intake facilities where packages are weighed and their labels are scanned or read and processed for postage charges. As illustrated, for example, a scanning device can identify and scan a postage label for its identifying indicia, the addressee zip code and the sender's instructions. The label identification data is then sent with a database query to the database in an attempt to match the label with information in a database (or, more generally, a data structure) of valid labels and payment accounts. The database may typically be centrally maintained and accessed by various post offices through a wide area network. Alternatively, the database may be replicated locally or regionally in order to improve access time.

FIG. 2 shows a proposed data structure for the database where a Label Table contains a list of all unique identifiers for the labels and associates an attribute with each identifier to indicate whether or not such label has be used. The Book Table provides the association of each unique identifier for each book of labels to all of the unique identifiers of the labels contained in each book. The Credit Card Table is created at the time a postal customer purchases a book of labels and the customers name and credit card (or other payment account) information is captured. The Purchase Table is also created at the time a postal customer purchases a book of labels and provides the association of the customer's credit card (or other payment account) to the book of labels and therefore to each label contained in the book of labels.

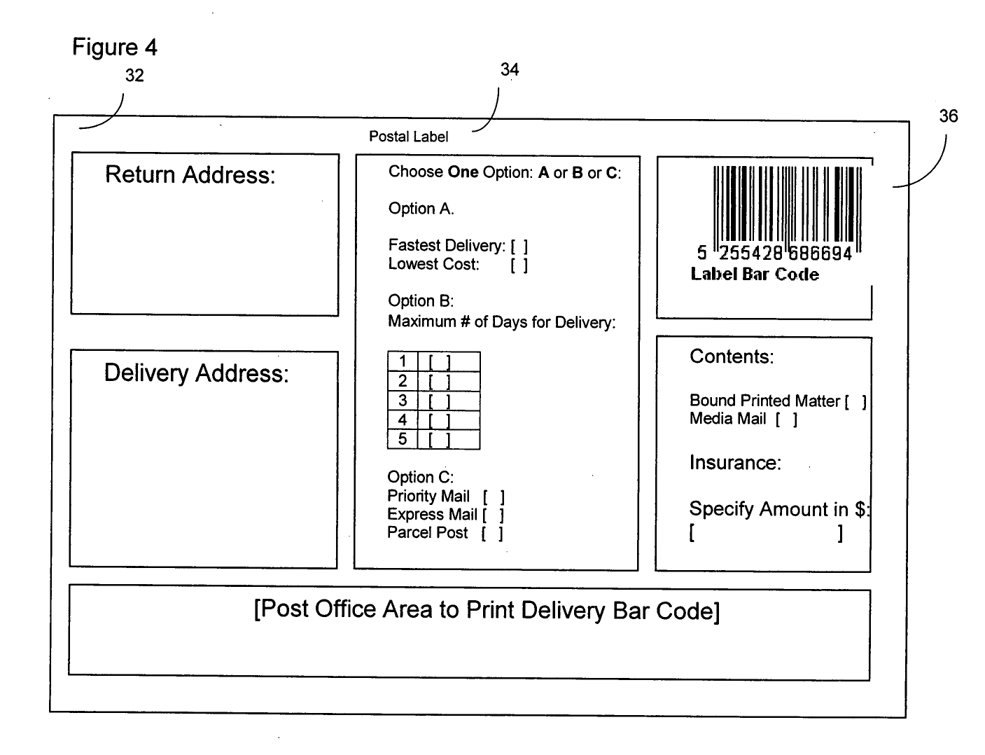

FIG. 4 shows a typical printed type of label 22 for use in a system and process as described herein, together with an optical scanner. On the surface 32 there is printed (a) a design or code 34 which identifies the label as a postage label and (b) the unique identifier 36, here represented as a bar code pattern.

Labels may be purchased in single quantities or in multiple sets, packaged in any way that is convenient and suitable (e.g., for vending machines). Indeed, labels may be assembled into sheets or books for dispensing through conventional postage stamp vending machines. Labels may also be printed on suitable label stock at a personal computer printer, after a user accesses secure a web site, for example, run by the post office.

In a further alternative implementation of the above-described methodology, a customer may first obtain a label or labels for free (or low cost), without having to engage in any transaction and without having to “activate” the labels at that time. Such labels could be obtained from a post office, store or other vendor, or on-line. At a later time, the customer can “activate” a label or group of labels by, for example, peeling off an adhesive strip which seals a book of labels on which is printed a toll-free telephone number, and then calling the telephone number and inputting billing information for a credit card or bank account with electronic bill payment capability, or similar information for another payment mechanism (e.g., third-party account), and the label identifier(s). That data is then added to the post office database and the label(s) is(are) identified as having been activated and made available for use. This way, the book of labels can be picked up by a customer at a store or at a post office without having to engage in any transaction at that time (and therefore these locations would not have to modify their existing systems currently in place to scan or input the necessary information into the database). The customer can completely avoid waiting in line and the post office can avoid the expense of having a clerk attend to the customer and of extra equipment. When a package bearing a label is scanned at the post office, the system determines whether the label has been activated before approving a postage charge. Blank, unactivated labels have no value, even if stolen. The post office can establish any policies it desires to use to pre-approve accounts that can be charged, so as to minimize the risk of non-payment. Both the physical label and the data in the database have to be valid for a transaction to be approved. Otherwise, the package is rejected. To reduce the risk a package will be thus rejected, it is suggested that if a post office allows this alternative of delayed activation of labels after distribution, the post office should provide a mechanism by which the customer not only can effect the later activation/validation, but also by which the customer can check on the status of a label. For example, the unique identifier of the label can be printed on the label not only in machine-readable format but also in human-readable format (or in association with the unique identifier on the outside of a book of labels). Then, in association with a web site interactive with the post office database or via a telephone inquiry system (e.g., keypad driven), the customer can input the label's unique identifier and obtain a status report. The status report preferably will be limited to valid/invalid (or activated/unactivated) and will not disclose payment account information in order to protect the privacy of such information. Optionally, the customer can be given the opportunity to provide a password or other security key at the time of activating the label, and can request further status information by supplying that password or security key, in any manner typically used to protect private data. Additional capabilities can be provided, such as allowing the customer to change the payment account.

In a still further alternative implementation of the above-described methodology, a customer may use labels in the manner described above, but instead of the labels being processed by a post office, the labels would be sold and processed by a company that processes packages and then delivers them to a post office or private shipper (a “package processor”). In this implementation, the package processor sells the labels, maintains the database, and charges the customer payment accounts for the appropriate shipping charge, and then places actual postage on the package and delivers the package to a post office, or in the case of a package to be shipped by a private shipper such as FedEx or UPS, places its account information on the package for appropriate billing. For example, a retail store that maintains a package delivery counter for its customers could use this system to enable customers to drop off packages without waiting for one of their employees to process the package, which processing could be done more efficiently and for less cost at another time. Another advantage of this system is that the retail store could negotiate lower rates with private shippers (as compared to the rate the customer can obtain) as the private shippers would only have to bill one customer, the retail store. Another advantage is that the retail store could minimize each customer's shipping costs by calculating (automatically) which of multiple shippers has the lowest rate for each particular package, and directing the package to that shipper, without requiring the customer to spend the time and effort to make that determination.

The methods discussed above and shown in the drawing figures are, as previously noted, examples and not restrictions on how the invention may be practiced. For example, these methods may include additional acts or steps. Further, the order of the acts performed as part of these methods is not limited to the order illustrated in any figure, unless the context clearly requires, as the acts may be performed in other orders, and one or more of the acts may be performed in series or in parallel to one or more other acts, or parts thereof. None of the claims set forth below is intended to be limited to any particular implementation unless such claim includes a limitation explicitly reciting a particular implementation.

Computer-implemented acts incorporated into practice of the methods and apparatus may be defined by computer-readable signals tangibly embodied on a computer-readable medium, for example, a non-volatile recording medium, an integrated circuit memory element, or a combination thereof. Such signals may define instructions, for example, as part of one or more programs that, as a result of being executed by a computer, instruct the computer to perform one or more of the methods or acts described herein, and/or various embodiments, variations and combinations thereof. Such instructions may be written in any of a plurality of programming languages, for example, Java, Visual Basic, C, C#, or C++, Fortran, Pascal, Eiffel, Basic, COBAL, etc., or any of a variety of combinations thereof. The computer-readable medium on which such instructions are stored may reside on one or more of the components of the system, and may be distributed across one or more of such components. The instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

It should be appreciated that any single component or collection of multiple components of a computer system that perform the functions described above with respect to, or with reference to, the method can be generically considered as one or more controllers that control the above-discussed functions. The one or more controllers can be implemented in numerous ways, such as with dedicated hardware, or using a processor that is programmed using microcode or software to perform the functions recited above. Data processing aspects of the invention may be implemented in software, hardware or firmware, or any combination thereof. Further, such methods, acts, systems, system elements and components thereof may be implemented as part of the computer system described above or as an independent component. It should be understood that the invention is not limited to a particular computer system platform, processor, operating system, or network. Also, it should be apparent to those skilled in the art that the present invention is not limited to a specific programming language or computer system.

One or more portions of the computer system may be distributed across one or more computer systems (not shown) coupled to a communications network. These computer systems also may be general-purpose computer systems. For example, various aspects of the invention such as database management and unique identifier validation or payment account billing may be distributed among one or more computer systems configured to provide a service (e.g., servers) to one or more client computers (e.g., label readers), or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Having thus described an inventive concept and embodiments for practicing such concept, it will be appreciated that the embodiments discussed herein are presented by way of example only and are not intended as limiting. Various alterations thereto and other embodiments will readily occur to those skilled in the art and it is intended that they be suggested by this disclosure. For example, the discussion of the invention in the context of a “post office” is not meant to imply the invention is useful only in connection with a governmental postal authority. “Post office” should be understood as encompassing private, non-governmental package delivery services as well as governmental package delivery services. Moreover, although some of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any means, known now or later developed, for performing the recited function. The invention is thus limited only as required by the following claims and equivalents thereto.

1. A method for posting mail packages by a postal customer, comprising:
a. the postal customer purchasing with a credit card coupled to a credit card account a label having a unique identifier, said purchase including authorizing subsequent postage charges to said credit card account;
b. in a data structure, associating the label identifier with said credit card;
c. in a computer which reads information from said data structure, determining if the label identifier has been not been used or otherwise cancelled, i.e., is valid, and correspondingly updating the data structure;
d. at or subsequent to the purchase, the postal customer affixing the label to a package to be delivered by the post office and delivering, or arranging for the delivery of, the package to a post office;
e. at a postal facility, scanning the label and obtaining from the package other information completed by the postal customer to enable determination of the appropriate postage; and
f. accessing the data structure to determine whether the label identifier is valid, and if so, to charge the determined postage to the postal customer's credit card, without any further interaction with the postal customer after the purchase of the package of labels.

2. The method of claim 1 wherein the credit card is not issued by the post office and the postal customer does not have to establish an account with the post office.

3. The method of claim 1 wherein the credit card is issued by the post office.

4. A method for posting mail packages by a postal customer of a post office, comprising:
a. the postal customer purchasing a label having a unique identifier, said purchase including authorizing subsequent postage charges to be debited from a third-party account of the customer;
b. in a computer data structure, the post office associating the label identifier with said third-party account;
c. operating a computer to determine, from a data structure, whether the label identifier is valid (i.e., has been not been used or otherwise cancelled);
d. at or subsequent to the purchase, the postal customer affixing the label to a package to be delivered by the post office and delivering, or arranging for the delivery of, the package to a post office;
e. at a postal facility, scanning the label and obtaining from the package other information completed by the postal customer to enable determination of the appropriate postage; and
f. accessing the data structure to determine whether the label identifier is valid, and, if so, debiting the determined postage from the third-party account, without any further interaction with the postal customer after the purchase of the package of labels.

5. The method of claim 4 wherein the third-party account is a bank account of the customer.

6. The method of claim 4, wherein the third-party account is an account maintained by the customer with the third-party and the third-party charges a fourth-party credit account of the customer and pays the post office.

7. The method of any of claims 1-6, wherein the post office is a governmental or quasi-governmental organization.

8. The method of any of claims 1-6, wherein the post office is a private shipper of packages.

9. The method of any of claims 1-6, wherein the unique identifier on the label is machine readable.

10. The method of claim 9, wherein the unique identifier is a printed bar code.

11. The method of claim 9, wherein the unique identifier is an RFID tag.

12. The postage label vending method according to any of claims 1-6, further including limiting the amount of postage that may be charged to the account.

13. A postage system, comprising:
a. means for reading from a label a unique identifier associated with the label;
b. means responsive to the read unique identifier for identifying a payment account with which the label has been previously associated;
c. means for verifying the unique identifier as valid;
d. means for determining the postage required to deliver an item on which the label is placed; and
e. means responsive to the means for verifying, for, after verifying the validity of a unique identifier, charging the postage to the payment account.

14. The postage system of claim 13, wherein the payment account is a credit card account or a bank account.

15. A postage label vending system comprising:
a. means for reading a credit card;
b. means for associating a unique identifier from a postage label with a credit card account number read by the means for reading; and
c. means for storing the unique identifier in association with the credit card account number.

16. A method for posting mail packages by a postal customer, comprising:
a. the postal customer obtaining a label having a unique identifier;
b. the postal customer activating the label by associating the label in a postal data structure with a payment account of the customer and authorizing current or subsequent postage charges to said account;
c. at or subsequent to the activation, the postal customer affixing the label to a package to be delivered by the post office and delivering the package to a post office;
d. at a postal facility, scanning the label and obtaining from the package other information completed by the postal customer to enable determination of the appropriate postage; and
e accessing the data structure to determine whether the label identifier is valid, and if so, to charge the determined postage to the associated account, without any further interaction with the postal customer.

17. A method for posting mail packages by a customer of a package processor, comprising:
a. the customer purchasing with a payment account, a label having a unique identifier, said purchase including authorizing subsequent shipping charges to said account;
b. in a data structure, associating the label identifier with said account;
c. operating a computer to access the data structure, determine if the label identifier has been not been used or otherwise cancelled, i.e., is valid, and update the data structure correspondingly;
d. at or subsequent to the purchase, the customer affixing the label to a package and the customer delivering, or arranging for the delivery of, the package to the package processor;
e. at a package processor, scanning the label and obtaining from the package other information completed by the customer to enable determination of the appropriate shipping charge;
f. operating a computer to access the data structure to determine whether the label identifier is valid, and, if so, to charge the determined shipping charge to the payment account, without any further interaction with the customer after the purchase of the package of labels;
g. placing the appropriate postage on the package if the package is to be delivered to a post office, or placing on the package an account number established by the package processor with a private shipper if the package is to be shipped by a private shipper; and
h. delivering the package to a post office which processes the package using the postage placed on the package by the package processor or delivering the package to a private shipper which bills the appropriate shipping cost to the package processor using the package processor's account number.
